(19) United States
(12) Patent Application Publication
(10) Pub. No.: US 2007/0003826 A1
(43) Pub. Date: Jan. 4, 2007

(54) Electronic device

(75) Inventor: Ching-Chang Hsu, Banciao City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Hannspree Inc.

(21) Appl. No.: 11/252,895

(22) Filed: Oct. 18, 2005

(30) Foreign Application Priority Data
Jul. 4, 2005 (TW) 94211258

(51) Int. Cl. H01M 2/10

(52) U.S. Cl. 429/97; 429/100

(57) ABSTRACT

An electronic device. The electronic device includes a body and a battery base. The battery base is disposed in the body in a detachable manner and has a first arm and a second arm for clamping a coin battery.

### BACKGROUND

The invention relates to an electronic device, and in particular, to an electronic device that having a battery base with arms for clamping a battery.

Referring to FIG. 1, a battery holder 11 of a conventional electronic device 10 comprises one or two holding member 12 (there are two in FIG. 1) and an elastic plate 13. The holding members 12 are located on two sides of the battery holder 11 respectively. A coin battery C can be received by the battery holder 11 between the holding members 12. The elastic plate 13 is disposed on the battery holder 11. When the battery C is clamped between the holding members 12, the elastic plate 13 pushes and firmly holds the battery C by its elasticity. Thus, the battery C is not easily dislodged, as the elastic plate 13, coupled to the battery, transmits voltage to the electronic device 10.

However, the curvature of the elastic plate 13 may be uneven. Elastic fatigue may also occur in the elastic plate 13 after time, such that the battery C is not held firmly in the battery holder 11, causing poor connection between the battery C and the elastic plate 13, such that the voltage transmission is interrupted.

### SUMMARY

Accordingly, the invention provides an electronic device. The electronic device comprises a body and a battery base. The battery base is disposed in the body in a detachable manner and comprises a first arm and a second arm, both clamping a coin battery.

The battery base can comprise an inner surface, corresponding to a circumference of the coin battery, between the first arm and the second arm.

The battery base can further comprise a support portion disposed at a top edge or a bottom edge of the inner surface, supporting the coin battery.

The coin battery may comprise a top surface and a bottom surface. The support portion may comprise a top support member and a bottom support member. The top support member abuts the top surface, and the bottom support member abuts the bottom surface.

A hook may be formed on ends of the first arm and the second arm respectively.

The battery base can further comprise a cap interconnecting the first arm and the second arm.

The cap can comprise an operating portion and an engaging portion. The engaging portion extends from one end of the operating portion. A section of the operating portion protrudes out of the cap to receive an external force.

The cap may further comprise an elastic member disposed on another end of the operating portion, providing a restoring force on the engaging portion. The elastic member is a spring.

The body may have a notch corresponding to the engaging portion. When the battery base combines with the body, the engaging portion enters the notch.

### DESCRIPTION OF THE DRAWINGS

The invention can be more fully understood by reading the subsequent detailed description and examples with references made to the accompanying drawings, wherein:

FIG. 1 is a schematic view of a conventional electronic device;

FIGS. 2 and 3 are schematic views of an electronic device of the invention;

FIGS. 4A and 4B are top and bottom views of a battery base of the invention;

FIGS. 5A, 5B, and 5C are schematic views of the battery base assembled with a battery;

FIG. 6 is a schematic interior view of the electronic device in FIG. 2.

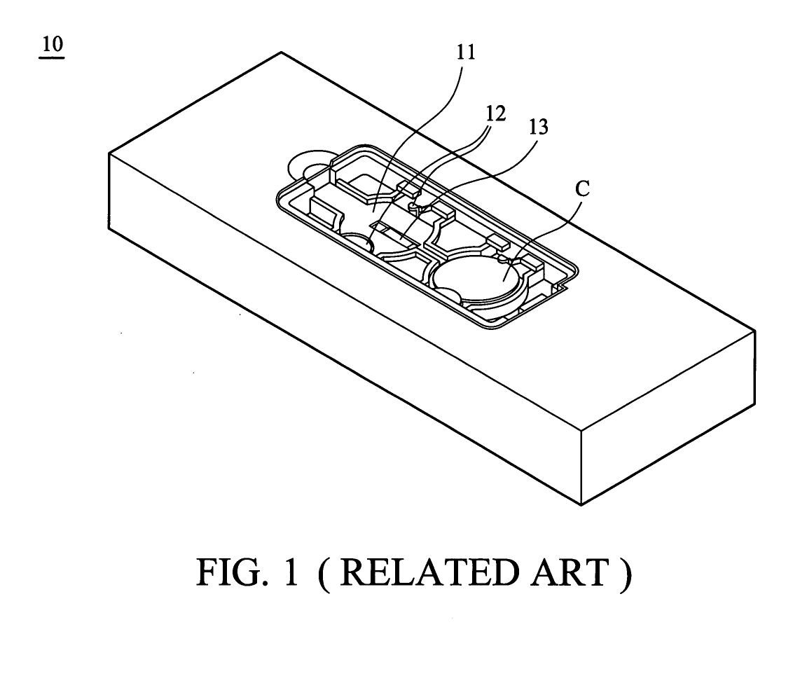

### DETAILED DESCRIPTION

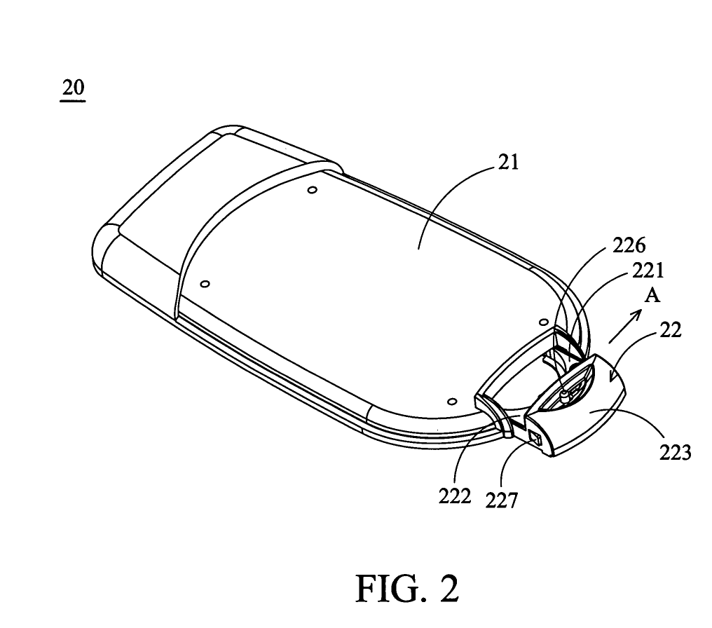

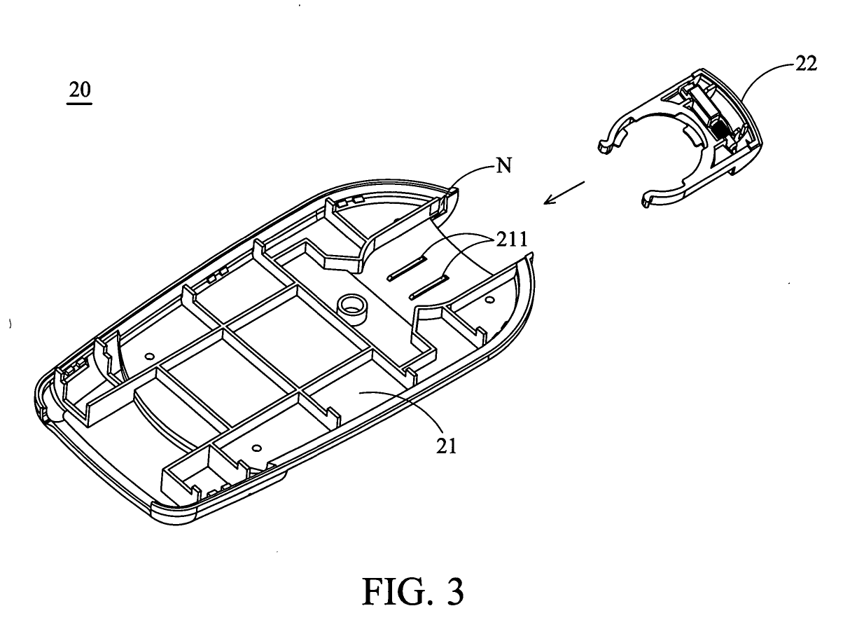

FIGS. 2 and 3 depict an electronic device 20 of the invention, showing an exterior and an interior view respectively. The electronic device 20 comprises a body 21 and a battery base 22, wherein the battery base 22 is disposed on the body 21 in a detachable manner. The body 21 comprises two connecting plates 211 and a notch N, wherein the connecting plates 211 transmits voltages.

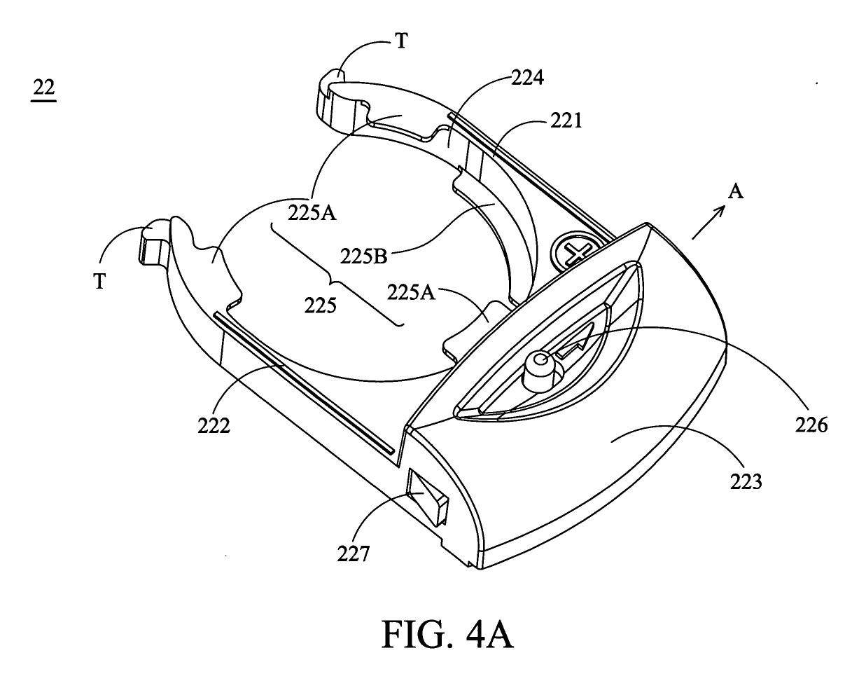

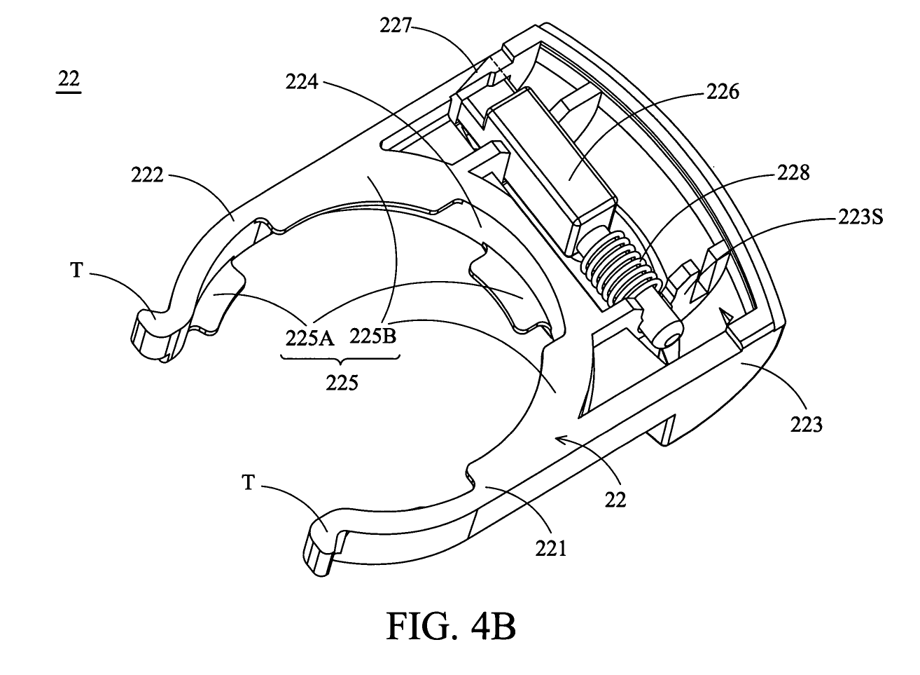

FIGS. 4A and 4B depict the battery base 22 showing a top and a bottom view respectively. The battery base 22 has a first arm 221, a second arm 222, a cap 223, an inner surface 224, a support portion 225, an operating portion 226, an engaging portion 227, and an elastic member 228. The engaging portion 227 corresponds to the notch N of the body 21.

It should be noted that while the battery base 22 has two arms 221 and 222, it is not limited thereto. The number of the arms can vary according to demand, such as three arms clamping two batteries, and four arms clamping three batteries.

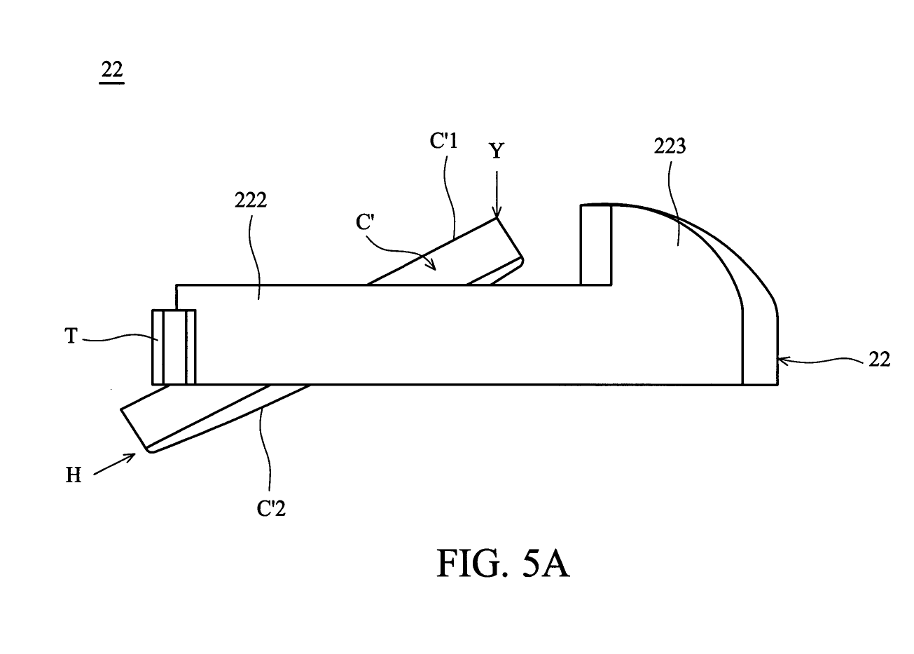

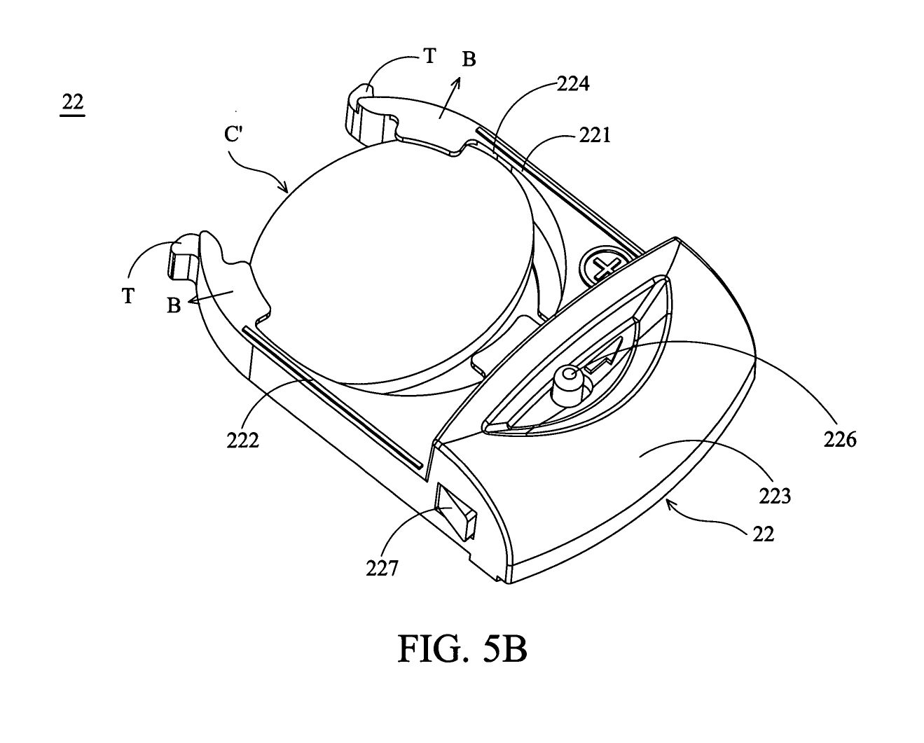

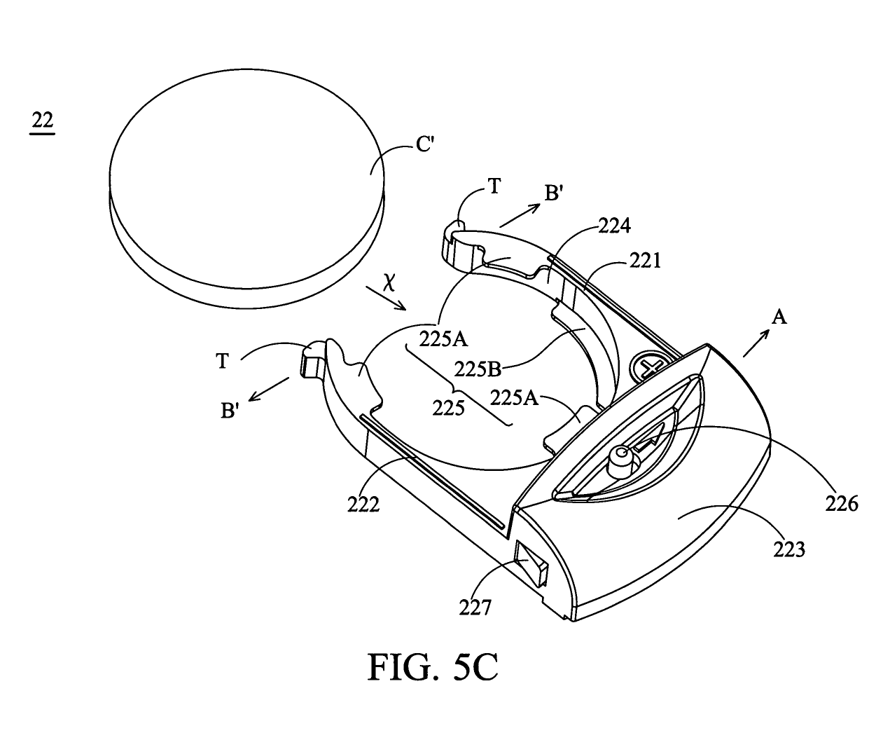

FIGS. 5A, 5B, and 5C depict the battery base 22 assembled with a battery C′. The first arm 221 and the second arm 222 are formed on two sides of the cap 223 respectively for clamping the battery C′. Two hooks T are formed at the end of the first arm 221 and the second arm 222. The inner surface 224 is formed by connecting the first arm 221, the second arm 222 and the cap 223, which is curved, corresponding to the circumference of the battery C′.

Referring to FIGS. 4A and 4B again, the support portion 225 comprises three top support members 225A and two bottom support members 225B. The battery C′ has a top surface C′1 and a bottom surface C′2 (as shown in FIG. 5A). The top support members 225A are disposed at the top edge of the inner surface 224, and the bottom support members 225B are disposed at the bottom edge of the inner surface 224. When the battery C′ is in the battery base 22, the top support members 225A abut the top surface C′1 of the battery C′, and the bottom support members 225B abut the bottom surface C′2 of the battery C′. The battery C′ is thus held between the first arm 221, the second arm 222, and the cap 223 by the support portion 225.

It should be noted that while the support portion 225 comprises three top support members 225A and two bottom support members 225B, it is not limited thereto. The support portion 225 can also comprise one or more top support members 225A and bottom support members 225B.

While the operating portion 226 is disposed in the cap 223, a portion thereto protrudes out of the cap 223 (as shown in FIG. 2). The engaging portion 227 extends from one end of the operating portion 226 (as shown in FIG. 4B). The elastic member 228 is a spring which is disposed on another end of the operating portion 226, abutting a stop portion 223S of an reverse side of the cap 223 (as shown in FIG. 4B).

Referring to FIGS. 5A, 5B, and 5C, the battery C′ is held between the first arm 221 and the second arm 222 in a sloped direction (direction H in FIG. 5A) corresponding to the battery base 22. A force perpendicular to the battery base 22 (direction Y in FIG. 5A) is applied on the battery C′, indirectly opening the hooks T of the first arm 221 and the second arm 222 (B in FIG. 5B), such that the battery C′ can be received in the battery base 22. Otherwise, the battery C′ is held between the first arm 221 and the second arm 222 in an X direction, parallel to the first arm 221 and the second arm 222 as shown in FIG. 5C. In this way, the battery C′ directly opens the hooks T of the first arm 221 and the second arm 222 (direction B′ in FIG. 5C) allowing the battery C′ to be received in the battery base 22.

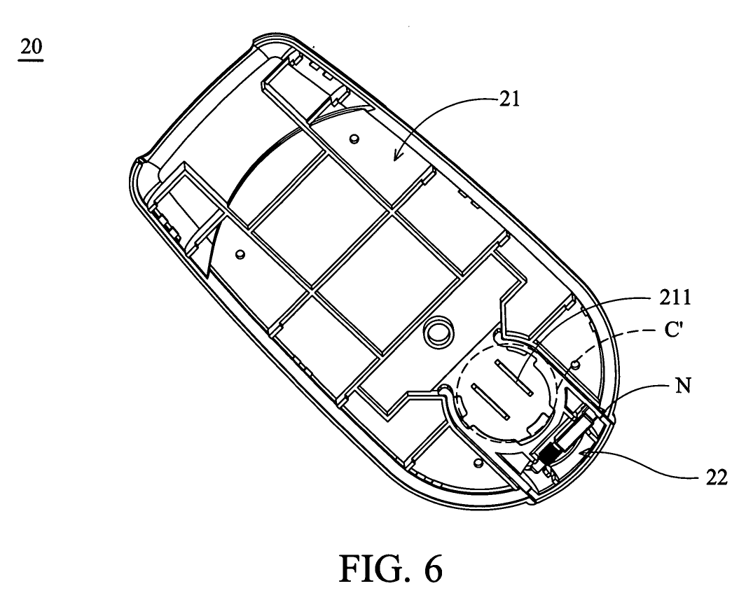

FIG. 6 is a schematic view of the electronic device 20 combined with the battery base 22. After the battery C′ is received in the battery base 22, the top surface C′1 and the bottom surface C′2 abut the top support member 225A and the bottom support member 225B respectively, securing the battery C′. When the battery base 22 is received in the body 21, the engaging portion 227 engages the notch N, utilizing the elasticity of the elastic member 228, immobilizing the battery base 22. The battery C′ simultaneously abuts the connecting plates 211 to transmit voltage to the body 21.

Separating of the battery base 22 and the body 21 requires force applied to the operating portion 226 in an A direction (as shown in FIG. 2). The operating portion 226 detaches the engaging portion 227 from the notch N for easy removal of the battery base 22 from the body 21.

The battery base 22 of the electronic device 20 utilizes the arms 221, 222 to secure the battery C′. The only function of the connecting plates 211 disposed on the body 21 is to transmit voltage. Thus, elastic fatigue of the connecting plates 211 is avoided, as is resulting power interrupt. The invention incorporates a battery cap into the battery base 22. The battery base 22 can be more easily removed than with a separate battery cap. The operating portion 226 and the engaging portion 227 firmly engage the battery base 22 within the body 21. Furthermore, the elastic member 228 on the operating portion 226 successfully immobilizes the engaging portion 227.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a body; and
a battery base, disposed in the body in a detachable manner, comprising a first arm and a second arm clamping a coin battery.

2. The electronic device as claimed in claim 1, wherein the battery base comprises an inner surface corresponding to a circumference of the coin battery, formed between the first arm and the second arm.

3. The electronic device as claimed in claim 2, wherein the battery base further comprises a support portion disposed at a top edge or a bottom edge of the inner surface for supporting the coin battery.

4. The electronic device as claimed in claim 3, wherein the coin battery comprises a top surface and a bottom surface, and the support portion comprises a top support member abutting the top surface, and a bottom support member abutting the bottom surface.

5. The electronic device as claimed in claim 1, wherein a hook is formed on ends of the first arm and the second arm respectively.

6. The electronic device as claimed in claim 1, wherein the battery base further comprises a cap interconnecting the first arm and the second arm.

7. The electronic device as claimed in claim 6, wherein the cap comprise:
an operating portion; and
an engaging portion extending from one end of the operating portion;
wherein a portion of the operating portion protrudes out of the cap for receiving an external force.

8. The electronic device as claimed in claim 7, wherein the cap further comprises an elastic member disposed on another end of the operating portion, providing a restoring force on the engaging portion.

9. The electronic device as claimed in claim 8, wherein the elastic member is a spring.

10. The electronic device as claimed in claim 7, wherein the body comprises a notch corresponding to and receiving the engaging portion when the battery base is combined with the body.
